(19) United States
(12) Patent Application Publication
(10) Pub. No.: US 2025/0340142 A1
(43) Pub. Date: Nov. 6, 2025

(54) POWER SUPPLY DEVICE, STORAGE MEDIUM, AND CONTROL METHOD

(71) Applicant: DENSO CORPORATION, Kariya-city (JP)

(72) Inventors: Takahiro Okada, Kariya-city (JP); Junji Miyachi, Kariya-city (JP)

(73) Assignee: DENSO CORPORATION, Kariya-city (JP)

(21) Appl. No.: 19/272,042

(22) Filed: Jul. 17, 2025

Related U.S. Application Data
(63) Continuation of application No. PCT/JP2023/046751, filed on Dec. 26, 2023.

(30) Foreign Application Priority Data
Jan. 20, 2023 (JP) 2023-007292

(51) Int. Cl. B60L 53/24; B60L 50/60; H02M 1/00; H02M 7/797

(52) U.S. Cl. CPC B60L 53/24; B60L 50/60; H02M 1/0009; H02M 7/797; B60L 2210/30; B60L 2210/42; B60L 2240/526; B60L 2270/142

(57) ABSTRACT

A power supply device is applicable to a system including an electrical storage unit, an inverter, a rotary electric machine, and a drive circuit. The power supply device includes a switching power supply having a power supply control unit. The switching power supply supplies power to the drive circuit by switching control of the power supply control unit. The drive circuit is operated when the power is fed from the switching power supply, and monitors a state of a switch of the inverter. The power supply control unit changes a switching manner of the switching power supply in a first state in which the electrical storage unit is externally charged through the inverter or switching control of the switch is stopped, from a switching manner of the switching power supply in a second state in which the switching control of the switch for driving the rotary electric machine is performed.

### CROSS-REFERENCE TO RELATED APPLICATION

The present application is based on and claims the benefit of priority from earlier Japanese Patent Application No. 2023-007292 filed on Jan. 20, 2023, the description of which is incorporated herein by reference.

### BACKGROUND

### Technical Field

The present disclosure relates to a power supply device, a storage medium, and a control method applicable to a system including an electrical storage unit, an inverter connected to the electrical storage unit, and a drive circuit that drives switches of the inverter.

### Related Art

As this type of power supply device, a device is known which intermittently activates a switching power supply feeding electric power to a drive circuit while external charge control for charging an electrical storage unit from an external power supply is performed.

### SUMMARY

An aspect of the present disclosure provides a power supply device applicable to a system, the system including an electrical storage unit, an inverter connected to the electrical storage unit, a rotary electric machine having armature windings connected to the inverter, and a drive circuit driving a switch of the inverter,
the power supply device including a switching power supply that has a power supply control unit and supplies electric power to the drive circuit by switching control of the power supply control unit, wherein
the drive circuit is operated when the electric power is fed from the switching power supply and has a function of monitoring a state of the switch, and
the power supply control unit performs a change process that changes a switching manner of the switching power supply in a first state in which the electrical storage unit is charged from an external power supply through the inverter or switching control of the switch is stopped, from a switching manner of the switching power supply in a second state in which the switching control of the switch for driving the rotary electric machine is performed.

### BRIEF DESCRIPTION OF THE DRAWINGS

In the accompanying drawings:

FIG. 1 is a diagram illustrating an overall configuration including a vehicle and an external charging device according to a first embodiment;

FIG. 2 is a diagram illustrating a configuration of an in-vehicle system;

FIG. 3 is a diagram illustrating a configuration of a PCU;

FIG. 4 is a flowchart of a change instruction process for a switching frequency performed by a microcomputer;

FIG. 5 is a flowchart of a switching control process for a control switch performed by a power supply control unit;

FIG. 6 is a diagram schematically illustrating effects achieved by decrease of the switching frequency;

FIG. 7 is a diagram illustrating a configuration of a PCU according to a second embodiment;

FIG. 8 is a flowchart of a change process for a target voltage performed by the microcomputer;

FIG. 9 is a flowchart of a switching control process for the control switch performed by the power supply control unit;

FIG. 10 is a diagram schematically illustrating effects achieved by decrease of the target voltage;

FIG. 11 is a diagram illustrating a configuration of a PCU according to a third embodiment;

FIG. 12 is a diagram illustrating an example of a gate switching circuit;

FIG. 13 is a flowchart of a change process for a gate resistance value performed by the microcomputer;

FIG. 14 is a flowchart of a switching control process for the control switch performed by the power supply control unit;

FIG. 15 is a diagram illustrating a configuration of a PCU according to a fourth embodiment;

FIG. 16 is a flowchart of a change instruction process for a switching frequency performed by the microcomputer;

FIG. 17 is a diagram illustrating a configuration of a PCU according to a fifth embodiment;

FIG. 18 is a flowchart of a change instruction process for a switching frequency performed by the microcomputer;

FIG. 19 is a diagram illustrating a configuration of a PCU according to a sixth embodiment; and

FIG. 20 is a flowchart of a change instruction process for a switching frequency performed by the microcomputer;

### DETAILED DESCRIPTION OF THE PREFERRED EMBODIMENTS

As a power supply device, a device disclosed in JP-A-2022-118417 is known which intermittently activates a switching power supply feeding electric power to a drive circuit while external charge control for charging an electrical storage unit from an external power supply is performed. Hence, noise produced due to switching control of the switching power supply is reduced.

When the switching power supply is intermittently activated, the time period during which feeding electric power from the switching power supply to the drive circuit is stopped becomes long. During the time period during which feeding electric power is stopped, the drive circuit cannot be operated, whereby states of switches of an inverter (e.g., an overcurrent state or an overheat state) may not be able to be monitored by the drive circuit.

The present disclosure has a main object of providing a power supply device, a storage medium, and a control method that can continue feeding electric power from a switching power supply to a drive circuit while suppressing influence of noise.

With reference to the drawings, a plurality of embodiments will be described. In the plurality of embodiments, parts functionally and/or structurally corresponding to each other and/or parts associated with each other may be denoted by the same reference sign or reference signs whose hundreds or higher digits are different from each other. Regarding the corresponding parts and/or the associated parts, descriptions of other embodiments can be referred to.

### First embodiment

Hereinafter, a first embodiment embodying a power supply device according to the present disclosure will be described with reference to the drawings. The power supply device of the present embodiment is mounted to an electrically-driven vehicle such as an electric vehicle or a hybrid vehicle.

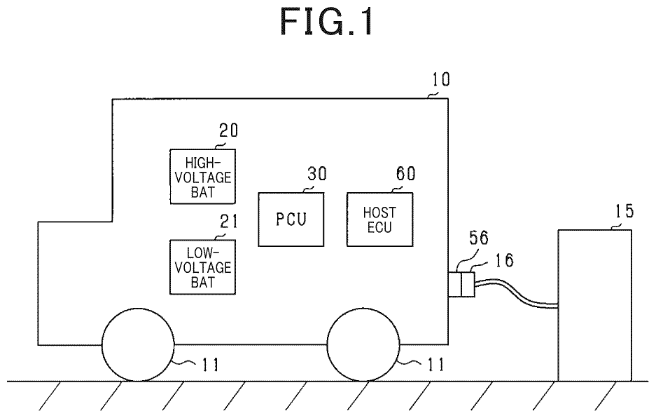

As illustrated in FIG. 1, as an in-vehicle system, a vehicle 10 includes wheels 11, a high-voltage storage battery 20 (corresponding to an electrical storage unit), a low-voltage storage battery 21, a power control unit (hereinafter, PCU) 30, and a host control unit (hereinafter, host ECU) 60. The high-voltage storage battery 20 is a chargeable and dischargeable secondary battery and has a terminal voltage of, for example, 100 V or higher. The high-voltage storage battery 20 is, for example, a lithium-ion storage battery or a nickel-hydrogen storage battery. The low-voltage storage battery 21 is a chargeable and dischargeable storage battery having output voltage (specifically, rated voltage) lower than that of the high-voltage storage battery 20, and is, for example, a lead storage battery. The low-voltage storage battery 21 has, for example, output voltage that is 1/10 or lower than the output voltage of the high-voltage storage battery 20.

The high-voltage storage battery 20 can be externally charged by an external charging device 15 (corresponding to an external power supply) disposed outside the vehicle 10. The external charging device 15 is, for example, a stationary device.

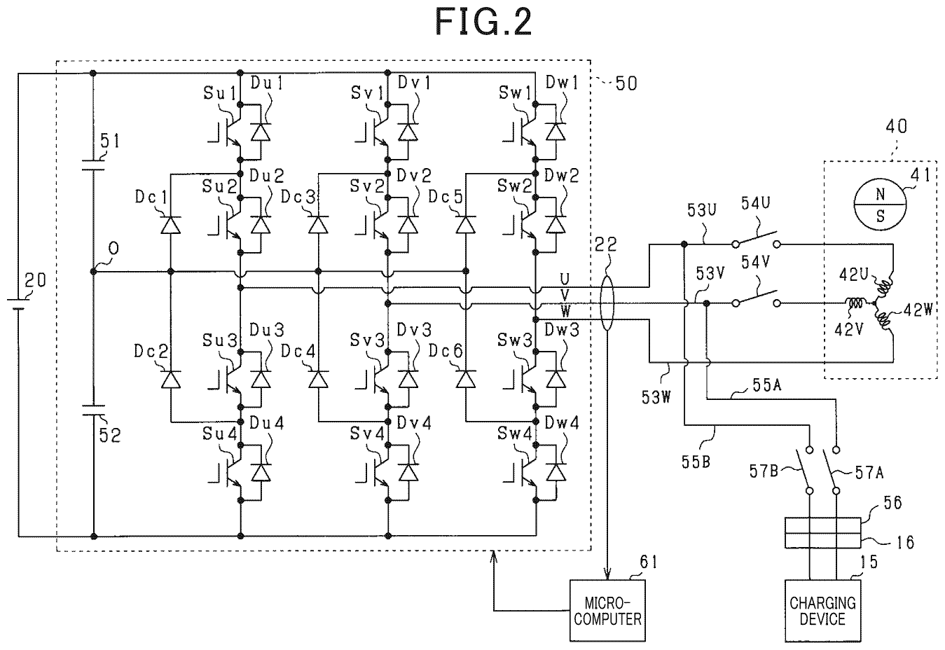

Next, with reference to FIG. 2, the PCU 30 and configurations related to external charging will be described.

The PCU 30 includes a rotary electric machine 40 and an inverter 50. The electric machine 40 applies rotative power to the wheels 11 (drive wheels) of the vehicle 10 to propel the vehicle 10. The rotary electric machine 40 of the present embodiment is a synchronous machine and, specifically, a Y-connection permanent magnet synchronous machine. The rotary electric machine 40 includes a rotor 41 that can transfer power to the drive wheels and U, V, W-phase windings 42U, 42V, 42W configuring a stator.

In the present embodiment, as an example of the inverter 50, a neutral point clamped 3-level inverter will be described. However, the configuration of the inverter 50 is not limited to a neutral point clamped type.

The inverter 50 includes U-phase first to fourth switches Su1 to Su4, V-phase first to fourth switches Sv1 to Sv4, W-phase first to fourth switches Sw1 to Sw4, a first capacitor 51, a second capacitor 52, and first to sixth clamp diodes Dc1 to Dc6. In the present embodiment, the switches Su1 to Su4, Sv1 to Sv4, Sw1 to Sw4 are voltage-controlled semiconductor switching elements, specifically, IGBTs. The switches Su1 to Su4, Sv1 to Sv4, Sw1 to Sw4 are connected with free-wheel diodes Du1 to Du4, Dv1 to Dv4, Dw1 to Dw4 in antiparallel.

The first capacitor 51 and the second capacitor 52 are connected in series. The series connection of the first and second capacitors 51, 52 is connected with the high-voltage storage battery 20 in parallel. The first capacitor 51 has, for example, the same capacitance as that of the second capacitor 52. In the present embodiment, the connection point of the first capacitor 51 and the second capacitor 52 is referred to as an inverter neutral point O.

The U-phase first to fourth switches Su1 to Su4 are connected in series in a state in which emitters, which are low-potential side terminals, and collectors, which are high-potential side terminals are connected. The collector of the U-phase first switch Su1 is connected with a positive electrode terminal of the high-voltage storage battery 20, and the emitter of the U-phase fourth switch Su4 is connected with a negative electrode terminal of the high-voltage storage battery 20. The connection point of the U-phase second switch Su2 and the U-phase third switch Su3 is connected with a first terminal of the U-phase winding 42U via a U-phase Conductive path 53U. The U-phase Conductive path 53U includes, for example, a conductive member such as a bus bar.

The connection point of the U-phase first switch Su1 and the U-phase second switch Su2 is connected with the cathode of the first clamp diode Dc1, and the anode of the first clamp diode Dc1 is connected with the cathode of the second clamp diode Dc2. The anode of the second clamp diode Dc2 is connected with the connection point of the U-phase third switch Su3 and the U-phase fourth switch Su4.

Configurations of the V and W-phases are basically the same as that of the U-phase. Hence, descriptions of the configurations of the V and W-phases are appropriately omitted. The connection point of the V-phase second switch Sv2 and the V-phase third switch Sv3 is connected with a first terminal of the V-phase winding 42V via a V-phase Conductive path 53V. The connection point of the W-phase second switch Sw2 and the W-phase third switch Sw3 is connected with a first terminal of the W-phase winding 42W via a W-phase Conductive path 53W. The V-phase Conductive path 53V and the W-phase Conductive path 53W include, for example, a conductive member such as a bus bar. Second terminals of the phase windings 42U, 42V, 42W are connected at the neutral point of armature windings.

Next, configurations related to external charging configuring the in-vehicle system will be described.

The in-vehicle system includes a U-phase disconnection switch 54U and a V-phase disconnection switch 54V, as configurations for electrically connecting or disconnecting the inverter 50 and the armature windings of the electric machine 40. When the disconnection switches 54U, 54V are turned on, bidirectional flows of current are permitted. When the disconnection switches 54U, 54V are turned off, bidirectional flows of current are interrupted.

The in-vehicle system includes a vehicle-side connector 56, a negative electrode wiring 55A, a positive electrode wiring 55B, a first selector switch 57A, and a second selector switch 57B, as configurations for electrically connect the inverter 50 to the external charging device 15.

The vehicle-side connector 56 is detachably connected with an external connector 16 of the external charging device 15. In a state in which the vehicle-side connector 56 and the external connector 16 are mechanically connected, a positive electrode terminal of the vehicle-side connector 56 and a positive electrode terminal 101 of the external charging device 15 are electrically connected. In addition, a negative electrode terminal of the vehicle-side connector 56 and a negative electrode terminal of the external charging device 15 are electrically connected.

The positive electrode wiring 55B connects a portion of the U-phase Conductive path 53U closer to the inverter 50 than the U-phase disconnection switch 54U and the positive electrode terminal of the vehicle-side connector 56. The positive electrode wiring 55B is provided with the second selector switch 57B. When the second selector switch 57B is turned on, bidirectional flows of current are permitted. When the second selector switch 57B is turned off, bidirectional flows of current are interrupted.

The negative electrode wiring 55A connects a portion of the V-phase Conductive path 53V closer to the inverter 50 than the V-phase disconnection switch 54V and the negative electrode terminal of the vehicle-side connector 56. The negative electrode wiring 55A is provided with the first selector switch 57A. When the first selector switch 57A is turned on, bidirectional flows of current are permitted. When the first selector switch 57A is turned off, bidirectional flows of current are interrupted.

The PCU 30 includes a current sensor 22. The current sensor 22 detects currents flowing to the Conductive paths 53U, 53V, 53W. Detection values of the current sensor 22 are input to a microcomputer 61 of the PCU 30.

The microcomputer 61 is a control unit included in the PCU 30 and performs drive control of the rotary electric machine 40 for propelling the vehicle 10 and external charge control.

The drive control of the rotary electric machine 40 controls a controlled variable (in the present embodiment, torque) of the rotary electric machine 40 to a command value (command torque Trq*) and is switching control of the switches Su1 to Sw4 of the inverter 50. When output voltage of the high-voltage storage battery 20 is Vh, and the potential of the inverter neutral point O is 0, the inverter 50 performs switching control of the switches Su1 to Sw4 to output any of three potentials Vh/2, 0, −Vh/2 different from each other to the phases of the rotary electric machine 40. Specifically, the U-phase will be exemplified. Turning on the U-phase first and second switches Su1, Su2 and turning off the U-phase third and fourth switches Su3, Su4 output Vh/2 to the U-phase of the rotary electric machine 40. Turning on the U-phase second and third switches Su2, Su3 and turning off the U-phase first and fourth switches Su1, Su4 output 0 to the U-phase. Turning on the U-phase third and fourth switches Su3, Su4 and turning off the U-phase first and second switches Su1, Su2 output −Vh/2 to the U-phase. It is noted that the command torque Trq* is input from the host ECU 60 to the microcomputer 61.

While the drive control of the rotary electric machine 40 is being performed, the host ECU 60 or the microcomputer 61 turns on the U-phase disconnection switch 54U and the V-phase disconnection switch 54V and turns off the first selector switch 57A and the second selector switch 57B.

The external charge control charges the high-voltage storage battery 20 from the external charging device 15 through the inverter 50 while the vehicle 10 is stopped, and is switching control for the switches of the inverter 50. In the present embodiment, the external charge control is performed by the host CPU 60. In the external charge control, the host CPU 60 itself or the microcomputer 61 instructed by the host CPU 60 turns off the U-phase disconnection switch 54U and the V-phase disconnection switch 54V and turns on the first selector switch 57A and the second selector switch 57B. It is noted that the switching control of the inverter 50 in the external charge control is a known technique disclosed, for example, in paragraphs to in JP-A-2021-52450, which is to be referred to.

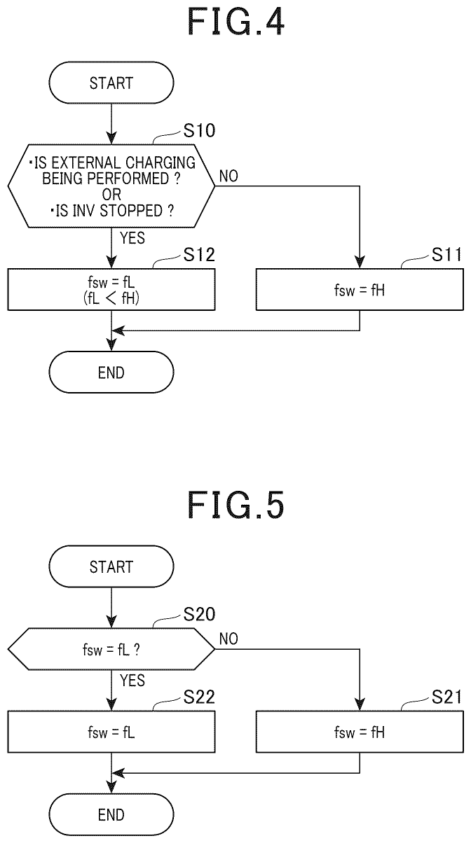

The microcomputer 61 and a microcomputer of the host CPU 60 include CPUs. Functions provided by the microcomputer 61 and the microcomputer of the host CPU 60 can be provided by software stored in a tangible memory device (storage medium) and a computer executing the software, only software, only hardware, or a combination For example, when the microcomputer 61 and the thereof. microcomputer of the host CPU 60 are provided by electronic circuits, which are hardware, they can be provided by digital circuits including a number of logic circuits or analog circuits. For example, the microcomputer 61 and the microcomputer of the host CPU 60 execute programs stored in non-transitory tangible storage mediums serving as storage units included therein. The programs include programs of processes illustrated in FIGS. 4, 5 and the like described later. When the programs installed in the microcomputer 61 and the microcomputer of the host CPU 60 are executed, methods corresponding to the programs are performed. The storage unit is, for example, a non-volatile memory. It is noted that the program stored in the storage unit can be downloaded or updated through a communication network such as OTA (Over The Air) and the Internet.

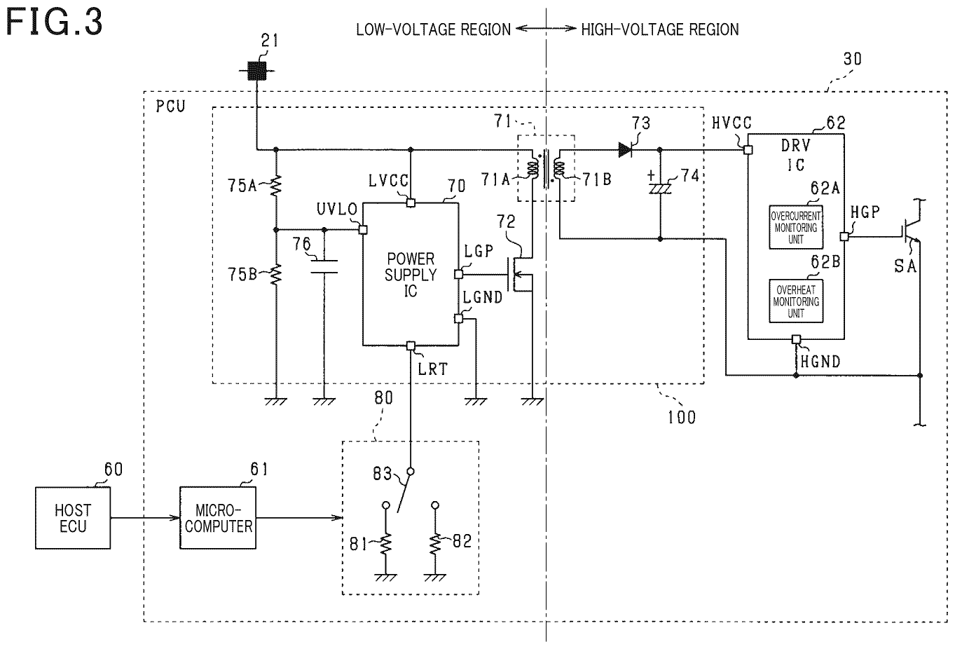

Next, with reference to FIG. 3, drive circuits 62 that drive the switches Su1 to Sw4 of the inverter 50 and an insulated power supply 100 that supplies output voltage of the low-voltage storage battery 21 to the drive circuit 62 will be described. It is noted that the switches Su1 to Sw4 of the inverter 50 have basically the same configurations. Hence, in FIG. 3, the switch of the inverter 50 is denoted by SA.

The PCU 30 includes the drive circuits 62 and the insulate power supply 100. The drive circuits 62 are configured by integrated circuits and are, for example, individually provided so as to correspond to the switches Su1 to Sw4. The drive circuit 62 receives a drive command signal for the switch SA from the microcomputer 61. The drive command signal is an on command signal or an off command signal.

The insulated power supply 100 of the present embodiment is a flyback switching power supply. The insulated power supply 100 includes a power supply IC 70 serving as a power supply control unit, a transformer 71, a control switch 72, first and second voltage-dividing resistors 75A, 75B, and a capacitor 76. The control switch 72 of the present embodiment is an N-channel MOSFET.

A first terminal of a primary coil 71A of the transformer 71 is connected with a positive electrode terminal of the low-voltage storage battery 21. A second terminal of the primary coil 71A is connected with the drain of the control switch 72, and the source of the control switch 72 is connected with the ground of a low-voltage region.

A power supply terminal LVCC of the power supply IC 70 is connected with the positive electrode terminal of the low-voltage storage battery 21. When electric power is fed from the low-voltage storage battery 21 to the power supply IC 70 through the power supply terminal LVCC, the power supply IC 70 can operate.

The gate of the control switch 72 is connected with a control termina LGP of the power supply IC 70. A ground terminal LGND of the power supply IC 70 is connected with the ground of the low-voltage region. The power supply IC 70 uses electric power input from the power supply terminal LVCC as a power source and supplies a charging current to the gate of the control switch 72 so that a voltage Vgs between the gate and the source, which is an electric potential of the control termina LGP with respect to an electric potential of the ground terminal LGND, becomes a threshold voltage of the control switch 72 or higher. Hence, the control switch 72 is turned on. In contrast, the power supply IC 70 flows a discharging current from the gate of the control switch 72 to the ground terminal LGND so that the voltage Vgs between the gate and the source becomes lower than the threshold voltage. Hence, the control switch 72 is turned off.

The power supply IC 70 performs switching control of the control switch 72 based on a duty ratio. The duty ratio is a ratio (=Ton/Tsw) of an on period Ton to one switching period Tsw of the control switch 72.

A first terminal of a series connection of the first and second voltage-dividing resistors 75A, 75B is connected with the positive electrode terminal of the low-voltage storage battery 21, and a second terminal of the series connection of the first and second voltage-dividing resistors 75A, 75B is connected with the ground of the low-voltage region. The connection point of the first and second voltage-dividing resistors 75A, 75B is connected with a detection terminal UVLO of the power supply IC 70.

It is noted that if determining that an input voltage at the detection terminal UVLO is lower than a voltage threshold value Vα, the power supply IC 70 performs a low voltage malfunction prevention process (Under Voltage Lock Out) for maintaining the control switch 72 in an off state. In contrast, if determining that the input voltage has exceeded a release threshold value VB that is higher than the voltage threshold value Vα and lower than the output voltage of the low-voltage storage battery 21, the power supply IC 70 stops the low voltage malfunction prevention process and restarts the switching control of the control switch 72 to restart operation of the insulated power supply 100.

The insulated power supply 100 includes a diode 73 and a capacitor 74. A first terminal of a secondary coil 71B of the transformer 71 is connected with the anode of the diode 73. The cathode of the diode 73 is connected with a first terminal of the capacitor 74 and a power supply terminal HVCC of the drive circuit 62. A second terminal of the secondary coil 71B is connected with a second terminal of the capacitor 74. When electric power is fed from the output side of the insulated power supply 100 to the drive circuit 62 through the power supply terminal HVCC, the drive circuit 62 can operate.

A control system is provided with the low-voltage region and a high-voltage region electrically insulated from the low-voltage region. The low-voltage region is provided with the low-voltage storage battery 21, the host ECU 60, and the microcomputer 61. The high-voltage region is provided with the high-voltage storage battery 20, the inverter 50, and the rotary electric machine 40. The insulated power supply 100 is provided across the low-voltage region and the high-voltage region. Specifically, the power supply IC 70, the control switch 72, the primary coil 71A, and the like are provided to the low-voltage region, and the secondary coil 71B, the drive circuit 62, and the like are provided to the high-voltage region.

The gate of the switch 24 of the inverter 50 is connected to a control terminal HSG of the drive circuit 62. A ground terminal HGND of the drive circuit 62 is connected with the source of the switch SA. If determining that an on command signal has been received, the drive circuit 62 uses electric power input from the power supply terminal HVCC as a power source and supplies a charging current to the gate of the control switch SA so that a voltage Vge between the gate and the source, which is an electric potential of the control termina HGP with respect to an electric potential of the ground terminal HGND, becomes a threshold voltage of the switch SA or higher. Hence, the switch SA is turned on. In contrast, if determining that an off command signal has been received, the drive circuit 62 flows a discharging current from the gate of the switch SA to the ground terminal HGND so that the voltage Vge between the gate and the source becomes lower than the threshold voltage. Hence, the switch SA is turned off.

The drive circuit 62 includes an overcurrent monitoring unit 62A and an overheat monitoring unit 62B. The overcurrent monitoring unit 62A acquires a detection value of a switch current sensor that detects a current flowing between the collector and the emitter of the switch SA. If determining that the acquired current of the switch SA has exceeded a current threshold value, the overcurrent monitoring unit 62A determines that the switch SA has caused an overcurrent abnormality and turns off the switch SA.

The overheat monitoring unit 62B acquires a detection value of a switch temperature sensor that detects a temperature of the switch SA. If determining that the acquired temperature of the switch SA has exceeded a temperature threshold value, the overheat monitoring unit 62B determines that the switch SA has caused an overheat abnormality and turns off the switch SA.

The PCU 30 includes a setting change unit 80 as a configuration for notifying the power supply IC 70 of a driving state and the like of the inverter 50. FIG. 3 illustrates an example in which the setting change unit 80 includes first and second resistors 81, 82 and a selector switch 83. The selector switch 83 connects any of the first and second resistors 81, 82 and a setting terminal LRT of the power supply IC 70. The resistance value of the first resistor 81 and the resistance value of the second resistor 82 are different from each other.

The microcomputer 61 receives, from the host ECU 60, information indicating that the external charge control is being performed, information indicating that the switching control of the switches Su1 to Sw4 of the inverter 50 is stopped, and information indicating that the drive control of the rotary electric machine 40 for propelling the vehicle 10 is being performed. If determining that the information indicating that the external charge control is being performed or the information indicating that the switching control is stopped has been received, the microcomputer 61 operates the selector switch 83 so that the setting terminal LRT and the first resistor 81 are connected. In contrast, if determining that the information indicating that the drive control of the rotary electric machine 40 is being performed has been received, the microcomputer 61 operates the selector switch 83 so that the setting terminal LRT and the second resistor 82 are connected. The input voltage at the setting terminal LRT depends on whether the resistor connected to the setting terminal LRT is the first resistor 81 or the second resistor 82. The power supply IC 70 can determine, based on the input voltage at the setting terminal LRT, whether the current state is a state in which the external charge control is being performed or the switching control of the inverter 50 is stopped (corresponding to a first state), or a state in which the drive control of the rotary electric machine 40 for propelling the vehicle 10 is being performed (corresponding to a second state).

It is required that, in a state in which the external charge control is being performed or the switching control of the inverter 50 is stopped, the level of noise produced due to switching control of the control switch 72 of the insulated power supply 100 (e.g., radiation noise, conduction noise) is a tolerance NLjde or lower in a specific frequency range Rfjde. This requirement is, for example, a legislative requirement. Specifically, for example, the requirement is established from the viewpoint of suppressing influence of noise on in-vehicle electronic devices. In order to satisfy the requirement, the microcomputer 61 performs processing illustrated in FIG. 4, and the power supply IC 70 performs processing illustrated in FIG. 5.

FIG. 4 is a flowchart of a process performed by the microcomputer 61.

In step S10, based on information transmitted from the host ECU 60, it is determined whether the current state is a state in which the external charge control is being performed or the switching control of the inverter 50 is stopped, or a state in which the drive control of the rotary electric machine 40 for propelling the vehicle 10 is being performed.

In step S10, if it is determined that the current state is a state in which the drive control of the rotary electric machine 40 is being performed, the process proceeds to step S11, in which the power supply IC 70 is instructed, through the setting change unit 80, to set a switching frequency fsw (=1/Tsw) of the control switch 72 to a first frequency fH (e.g., 400 kHz). Specifically, the selector switch 83 is operated so that the setting terminal LRT and the first resistor 81 are connected. When the lower limit of the specific frequency range Rfjde is RL, and the upper limit is RH, the first frequency fH is within the specific frequency range Rfjde (RL≤fH≤RH), and is specifically, for example, higher than the lower limit RL of the specific frequency range Rfjde and lower than the upper limit RH.

In contrast, in step S10, if it is determined that the current state is a state in which the external charge control is being performed or the switching control of the inverter 50 is stopped, the process proceeds to step S12, in which the power supply IC 70 is instructed, through the setting change unit 80, to set the switching frequency fsw of the control switch 72 to a frequency (e.g., 40 kHz) lower than the lower limit RL of the specific frequency range Rfjde. Specifically, the selector switch 83 is operated so that the setting terminal LRT and the second resistor 82 are connected. For example, when a second frequency fL is 40 kHz and the first frequency fH is 400 kHz, the second frequency fL is 1/10 of the first frequency fH.

The second frequency fL is, for example, 1/12 of the first frequency fH or higher and 1/6 of the first frequency fH or lower, preferably 1/11 of the first frequency fH or higher and 1/7 of the first frequency fH or lower, and more preferably 1/10.5 of the first frequency fH or higher and 1/7.5 of the first frequency fH or lower, or 1/10.5 of the first frequency fH or higher and 1/8 of the first frequency fH or lower.

It is noted that the second frequency fL is set to be lower than the first frequency fH (set to the low frequency side with respect to the first frequency fH) because, for example, characteristics of the transformer 71 (e.g., gain, phase, frequency characteristics of impedance) do not satisfy required characteristics in a frequency range higher than the upper limit RH of the specific frequency range Rfjde.

In addition, the second frequency fL is set to be lower than the first frequency fH (set to the low frequency side with respect to the first frequency fH) in order to, for example, suppress influence of the switching control of the control switch 72 on electronic devices included in the in-vehicle system. Specifically, the electronic devices include a radio receiver and a loudspeaker. The radio receiver includes an AM receiver and an FM receiver. The AM receiver detects and demodulates modulated waves that are obtained by modulating carrier waves using analog AM modulation, and outputs the demodulated waves to the loudspeaker as an audio signal. The FM receive detects and demodulates modulated waves that have been subjected to frequency modulation and outputs the waves to the loudspeaker as an audio signal. Herein, the frequency range that AM broadcast can employ is higher than the specific frequency range Rfjde (on the high frequency side with respect to the specific frequency range Rfjde), and is, for example, 510 to 1720 kHz. It is noted that the frequency range that FM broadcast can employ is further higher than the frequency range that AM broadcast can employ (on the high frequency side with respect to the frequency range that AM broadcast can employ), and is, for example, 76 to 108 MHZ.

If the switching frequency fsw of the control switch 72 is shifted so as to be higher than the upper limit RH of the specific frequency range Rfjde (shifted to the high frequency side with respect to the upper limit RH of the specific frequency range Rfjde), the frequency of noise produced due to the switching control of the control switch 72 may be included in the frequency range of AM broadcast. In this case, the noise is mixed in frequencies (sounds) of an audible range output from the loudspeaker, whereby the user feels uncomfortable. Hence, the second frequency fL is shifted so as to be lower than the first frequency fH (shifted to the low frequency side with respect to the first frequency fH).

FIG. 5 is a flowchart of a process performed by the power supply IC 70.

In step S20, based on the input voltage at the setting terminal LRT, it is determined whether the switching frequency fsw of the control switch 72 is indicated to be set to the first frequency fH or the second frequency fL.

In step S20, if it is determined that the switching frequency fsw is indicated to be set to the first frequency fH, the process proceeds to step S21, in which the switching control of the control switch 72 is performed so that the switching frequency fsw of the control switch 72 is the first frequency fH.

In contrast, in step S20, if it is determined that the switching frequency fsw is indicated to be set to the second frequency fL, the process proceeds to step S22, in which the switching control of the control switch 72 is performed so that the switching frequency fsw of the control switch 72 is the second frequency fL.

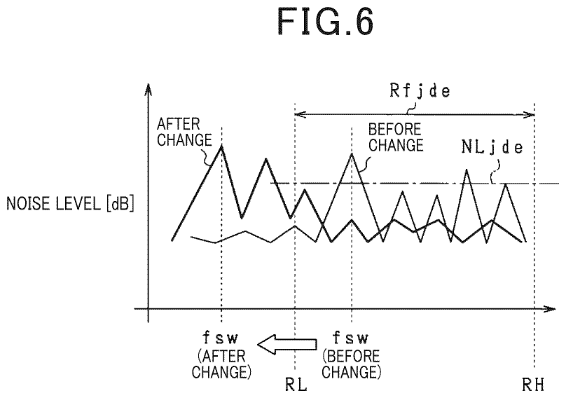

As illustrated in FIG. 6, when the switching frequency fsw is shifted to the second frequency fL lolwer than the lower limit RL of the specific frequency range Rfjde, the level of noise produced due to the switching control of the insulated power supply 100 can be lower than the tolerance NLjde or lower in the specific frequency range Rfjde.

According to the present embodiment described above in detail, the switching frequency fsw of the control switch 72 of the insulated power supply 100 is set to a frequency in the specific frequency range Rfjde when the vehicle 10 travels, and is set to a frequency outside the specific frequency range Rfjde when external charging is performed or the inverter 50 is stopped. Hence, when external charging is performed or the inverter 50 is stopped, electric power can be fed from the insulated power supply 100 to the drive circuits 62 while the level of noise is the tolerance NLjde or lower in the specific frequency range Rfjde. Thus, when external charging is performed or the inverter 50 is stopped, the overheat monitoring unit 62B can continue to monitor an overheat abnormality of the switch SA, and the overcurrent monitoring unit 62A can continue to monitor an overcurrent abnormality of the switch SA.

It is noted that power consumed by the drive circuit 62 when external charging is performed is lower than that consumed when drive control of the rotary electric machine 40 for propelling the vehicle 10 is performed. This is because, in the drive circuits 62, for example, the number of times of switching of the inverter 50 in a specified time period when external charging is performed is smaller than that when the drive control of the rotary electric machine 40 is performed. Hence, even when the switching frequency fsw of the insulated power supply 100 is lowered when external charging is performed, drive electric power for the switch SA supplied from the insulated power supply 100 to the drive circuit 62 can be suppressed from failing.

### Modification of First Embodiment

The switching frequency fsw of the control switch 72 may be set to a frequency higher than the upper limit RH of the specific frequency range Rfjde.

The host ECU 60 may not transmit information indicating that the switching control of the switches Su1 to Sw4 of the inverter 50 is stopped, to the microcomputer 61. In this case, in step S10 illustrated in FIG. 4, the state in which the switching control of the inverter 50 is stopped may be removed from the states to be determined based on the information transmitted from the host ECU 60.

### Second Embodiment

Hereinafter, a second embodiment will be described with reference to the drawings focusing on differences from the first embodiment. In the present embodiment, in order to make the level of noise equal to or lower than the tolerance NLjde in the specific frequency range Rfjde, instead of the switching frequency fsw of the control switch 72, output voltage of the insulated power supply 100 is lowered.

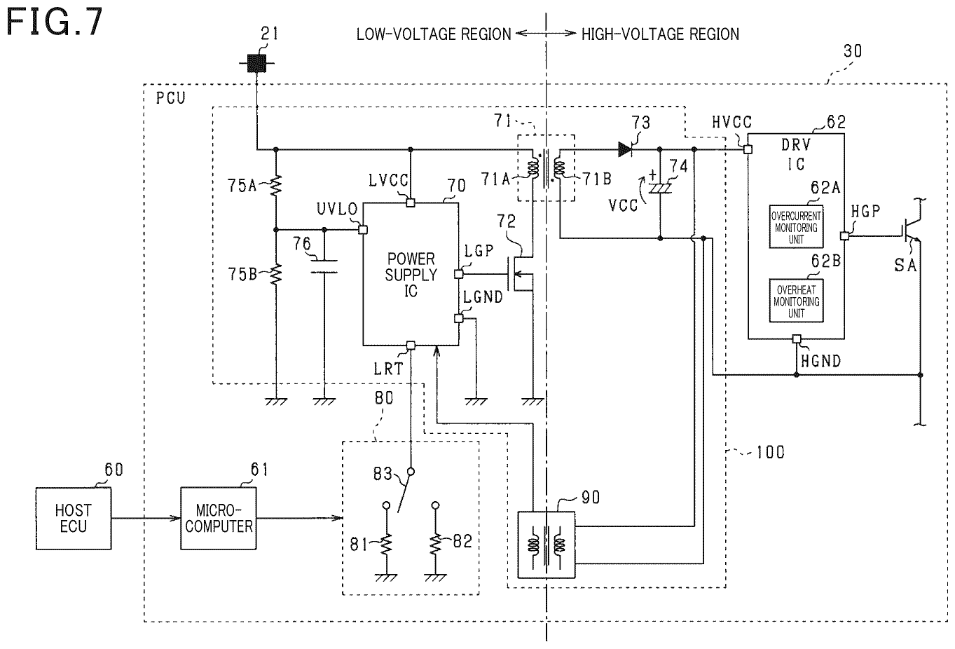

As illustrated in FIG. 7, the insulated power supply 100 includes a feedback coil 90 serving as a voltage detection coil. The feedback coil 90 detects an output voltage VCC (terminal voltage of the capacitor 74) of the insulated power supply 100 and transmits information on the detected output voltage VCC to the power supply IC 70. The power supply IC 70 performs the switching control of the control switch 72 based on the information input from the feedback coil 90, to feed back the output voltage VCC to a target voltage Vtgt.

If determining that an input voltage at the power supply terminal HVCC is lower than a voltage threshold value Vγ, the drive circuit 62 performs a low voltage malfunction prevention process (Under Voltage Lock Out) for maintaining the switch SA in an off state. In contrast, if determining that the input voltage has exceeded a release threshold value Vδ, the drive circuit 62 stops the low voltage malfunction prevention process and permits the switching control of the switch SA. The release threshold value Vδ has been set to a value larger than the voltage threshold value Vγ.

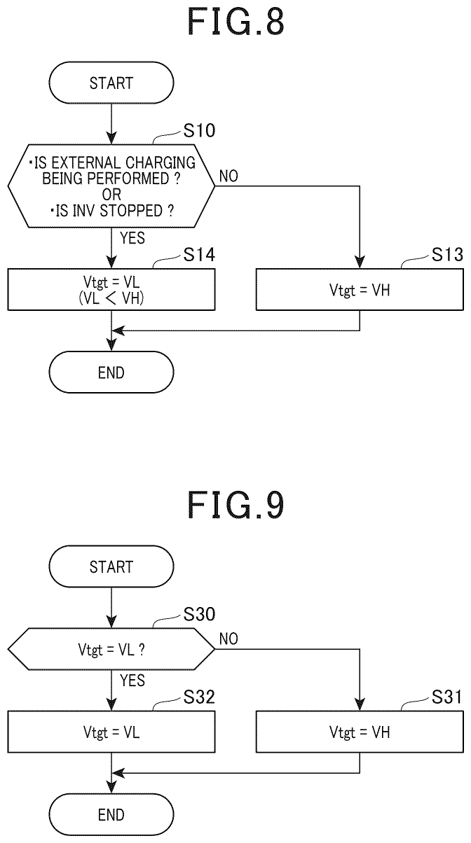

FIG. 8 is a flowchart of a process performed by the microcomputer 61.

In step S10, if it is determined that the current state is a state in which the drive control of the rotary electric machine 40 is being performed, the process proceeds to step S13, in which the power supply IC 70 is instructed, through the setting change unit 80, to set the target voltage Vtgt to a first voltage VH. Specifically, the selector switch 83 is operated so that the setting terminal LRT and the first resistor 81 are connected.

In contrast, in step S10, if it is determined that the current state is a state in which the external charge control is being performed or the switching control of the inverter 50 is stopped, the process proceeds to step S14, in which the power supply IC 70 is instructed, through the setting change unit 80, to set the target voltage Vtgt to a second voltage VL lower than the first voltage VH. Specifically, the selector switch 83 is operated so that the setting terminal LRT and the second resistor 82 are connected.

It is noted that the second voltage VL may be set to a value equal to or more than the voltage threshold value Vγ. Hence, due to lowering the level of noise, the low voltage malfunction prevention process can be prevented from being performed by the drive circuit 62.

FIG. 9 is a flowchart of a process performed by the power supply IC 70.

In step S30, based on the input voltage at the setting terminal LRT, it is determined whether the target voltage Vtgt is indicated to be set to the first voltage VH or the second voltage VL.

In step S30, if it is determined that the target voltage Vtgt is indicated to be set to the first voltage VH, the process proceeds to step S31, in which the target voltage Vtgt is set to the first voltage VH. Then, the switching control of the control switch 72 is performed to feed back the output voltage VCC of the insulated power supply 100 to the first voltage VH.

In contrast, in step S30, if it is determined that the target voltage Vtgt is indicated to be set to the second voltage VL, the process proceeds to step S32, in which the target voltage Vtgt is set to the second voltage VL. Then, the switching control of the control switch 72 is performed to feed back the output voltage VCC of the insulated power supply 100 to the second voltage VL. In this case, the duty ratio of the control switch 72 is set to be lower than that in the processing of step S31.

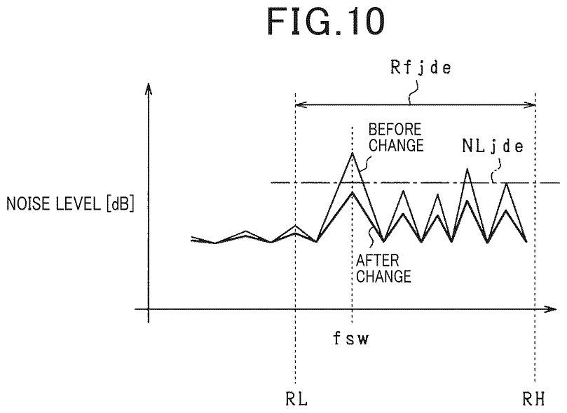

According to the present embodiment described above, as illustrated in FIG. 10, the level of noise produced due to the switching control of the insulated power supply 100 can be the tolerance NLjde or lower in the specific frequency range Rfjde.

### Third Embodiment

Hereinafter, a third embodiment will be described with reference to the drawings focusing on differences from the first embodiment. In the present embodiment, in order to make the level of noise equal to or lower than the tolerance NLjde in the specific frequency range Rfjde, instead of the switching frequency fsw of the control switch 72, switching speed of the control switch 72 is lowered.

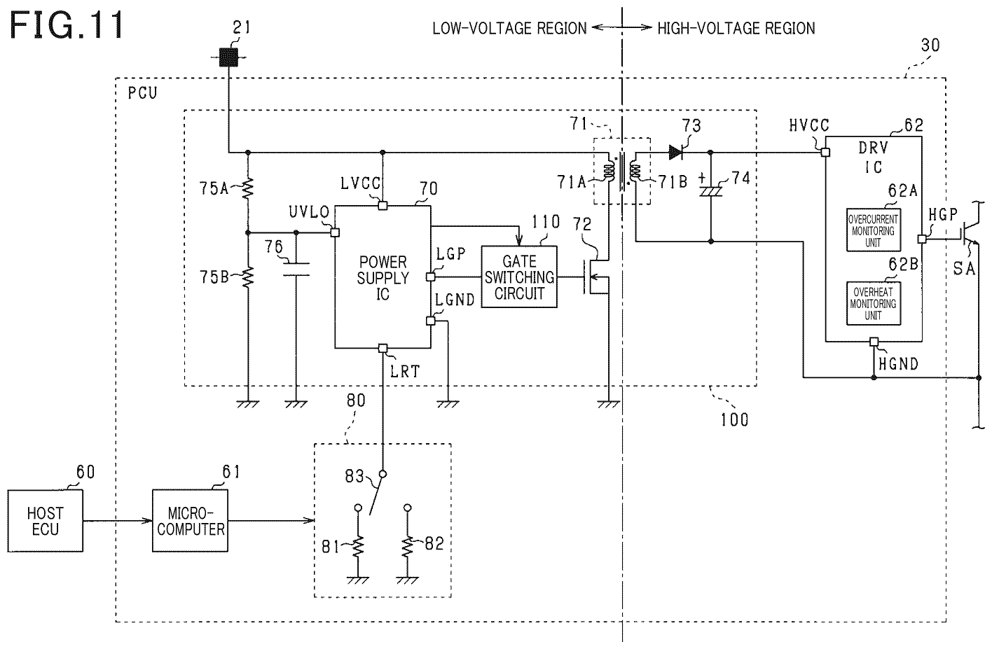

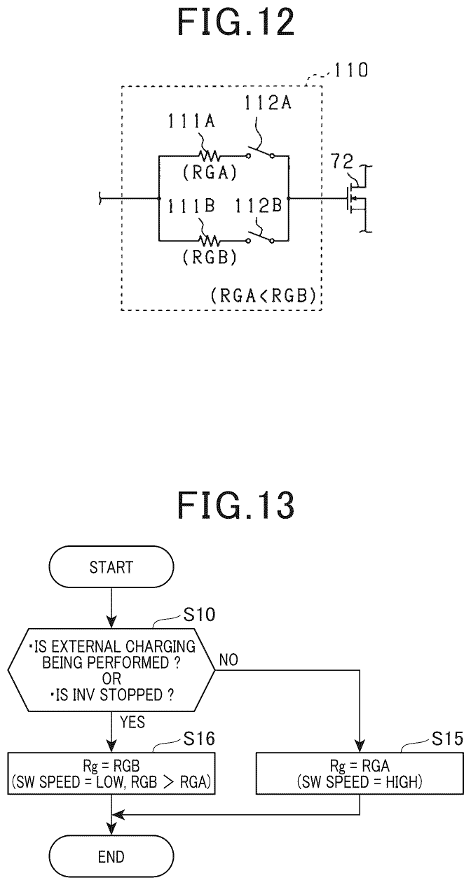

As illustrated in FIG. 11, the insulated power supply 100 includes a gate switching circuit 110 for changing switching speed of the control switch 72. The gate switching circuit 110 can employ various circuit configurations. FIG. 12 illustrates an example of the gate switching circuit 110. The gate switching circuit 110 includes a first gate resistor 111A, a second gate resistor 111B, a first charge and discharge switch 112A, and a second charge and discharge switch 112B. A series connection of the first gate resistor 111A and the first charge and discharge switch 112A connects the control termina LGP of the power supply IC 70 and the gate of the control switch 72. A series connection of the second gate resistor 111B and the second charge and discharge switch 112B also connects the control termina LGP of the power supply IC 70 and the gate of the control switch 72.

A resistance value RGA of the first gate resistor 111A is lower than a resistance value RGB of the second gate resistor 111B. The resistance value RGA of the first gate resistor 111A is, for example, 0.3*RGB≤RGA≤0.7*RGB, preferably, 0.4*RGB≤RGA≤0.6*RGB, and more preferably, 0.45*RGB≤RGA≤0.55*RGB.

FIG. 13 is a flowchart of a process performed by the microcomputer 61.

In step S10, if it is determined that the current state is a state in which the drive control of the rotary electric machine 40 is being performed, the process proceeds to step S15, in which the power supply IC 70 is instructed, through the setting change unit 80, to set the gate resistor connected to the gate of the control switch 72 to the first gate resistor 111A. Specifically, the selector switch 83 is operated so that the setting terminal LRT and the first resistor 81 are connected.

In contrast, in step S10, if it is determined that the current state is a state in which the external charge control is being performed or the switching control of the inverter 50 is stopped, the process proceeds to step S16, in which the power supply IC 70 is instructed, through the setting change unit 80, to set the gate resistor connected to the gate of the control switch 72 to the second gate resistor 111B. Specifically, the selector switch 83 is operated so that the setting terminal LRT and the second resistor 82 are connected.

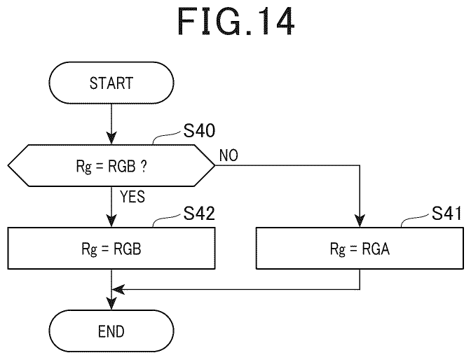

FIG. 14 is a flowchart of a process performed by the power supply IC 70.

In step S40, it is determined whether the gate resistor connected to the gate of the control switch 72 is indicated to be set to the second gate resistor 111B or the first gate resistor 111A. In step S40, if it is determined that the gate resistor is indicated to be set to the first gate resistor 111A, the process proceeds to step S41, in which the first charge and discharge switch 112A is turned on, and the second charge and discharge switch 112B is turned off. Then, the switching control of the control switch 72 is performed.

In contrast, in step S40, if it is determined that the gate resistor is indicated to be set to the second gate resistor 111B, the process proceeds to step S42, in which the second charge and discharge switch 112B is turned on, and the first charge and discharge switch 112A is turned off. Then, the switching control of the control switch 72 is performed. In this case, compared with the case of performing the processing of step S41, the switching speed can be lowered when the control switch 72 is turned on and when the control switch 72 is turned off. As a result, the level of harmonic components included in noise is lowered, whereby the level of the noise can be the tolerance NLjde or lower in the specific frequency range Rfjde.

### Modification of Third Embodiment

The gate switching circuit may be configured to be able to change the switching speed not both of when the control switch 72 is turned on and when the control switch 72 is turned off, but either of when the control switch 72 is turned on and when the control switch 72 is turned off.

The circuit that changes the switching speed of the control switch 72 is not limited to the circuit that changes the resistance value of the gate resistor, but may be a circuit that changes a power supply voltage of the gate of the control switch 72 or a circuit that changes the potential of the ground to which gate electric charge of the control switch 72 is discharged.

### Fourth Embodiment

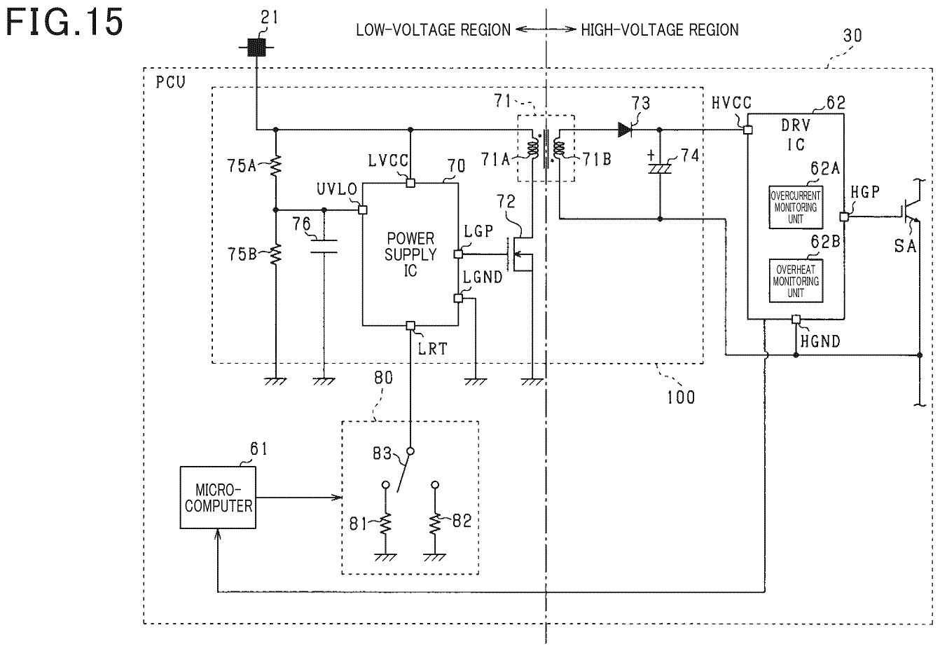

Hereinafter, a fourth embodiment will be described with reference to the drawings focusing on differences from the first embodiment. In the present embodiment, the switching frequency fsw is changed based on information inside the PCU 30 instead of the information transmitted from the host ECU 60 provided outside the PCU 30. Hence, in the present embodiment, as illustrated in FIG. 15, the PCU 30 is configured so that drive information of the drive circuit 62 is input to the microcomputer 61.

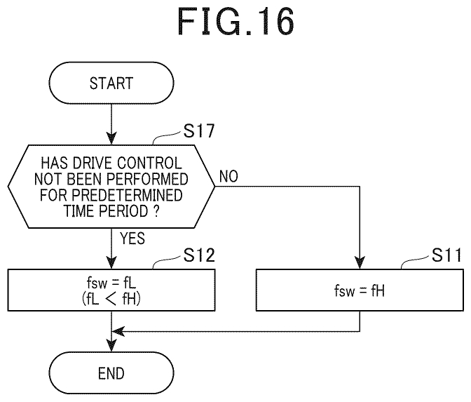

FIG. 16 is a flowchart of a process performed by the microcomputer 61.

In step S17, based on the drive information of the drive circuit 62, it is determined whether the drive control of the rotary electric machine 40 has not been performed for a predetermined time period. Specifically, for example, if the drive information is a gate voltage of the switch SA, it is determined whether the gate voltage of the switch SA has been maintained at 0 V for the predetermined time period. It is noted that the drive information is not limited to the gate voltage, but may be, for example, a drive command signal input to the drive circuit 62.

In step S17, if it is determined that the drive control of the rotary electric machine 40 has been performed for the predetermined time period, the process proceeds to step S11. In contrast, in step S17, if it is determined that the drive control of the rotary electric machine 40 has not been performed for the predetermined time period, the process proceeds to step S12.

According to the present embodiment described above, the change of the switching frequency fsw can be determined by the microcomputer 61 of the PCU 30 without depending on the information transmitted from the host ECU 60.

### Fifth Embodiment

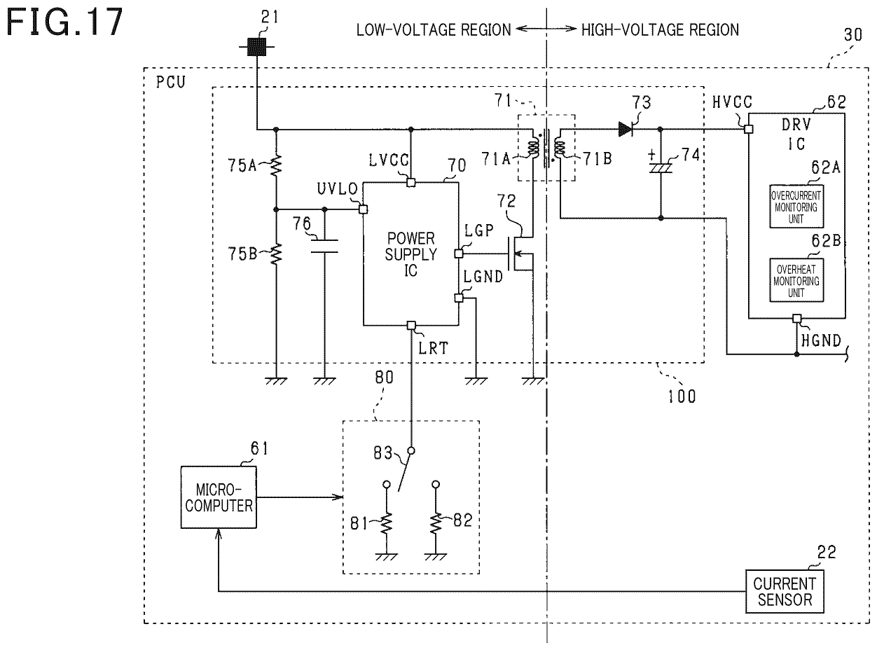

Hereinafter, a fifth embodiment will be described with reference to the drawings focusing on differences from the fourth embodiment. As illustrated in FIG. 17, if determining, based on a detection value of the current sensor 22, that a charging current is flowing from the inverter 50 to the high-voltage storage battery 20 by the external charge control, the microcomputer 61 changes the switching frequency fsw.

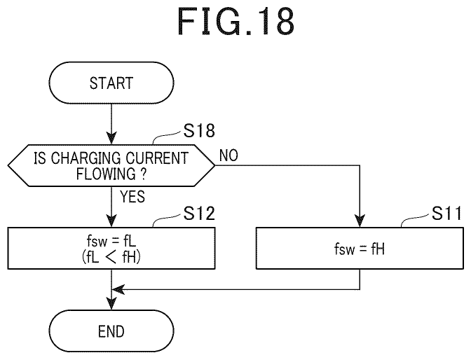

FIG. 18 is a flowchart of a process performed by the microcomputer 61.

In step S18, it is determined, based on a detection value of the current sensor 22, whether a charging current is flowing from the inverter 50 to the high-voltage storage battery 20. For example, if it is determined that the direction of flow of the current detected by the current sensor 22 and flowing through the U and V-phase Conductive paths 53U, 53V is toward the inverter 50 and the current detected by the current sensor 22 is DC current, it may be determined that a charging current is flowing.

In step S18, if it is determined that no charging current is flowing, the process proceeds to step S11. In contrast, in step S18, if it is determined that a charging current is flowing, the process proceeds to step S12.

According to the present embodiment described above, when external charge control is being performed, the change of the switching frequency fsw can be determined by the microcomputer 61 of the PCU 30 without depending on the information transmitted from the host ECU 60.

### Sixth Embodiment

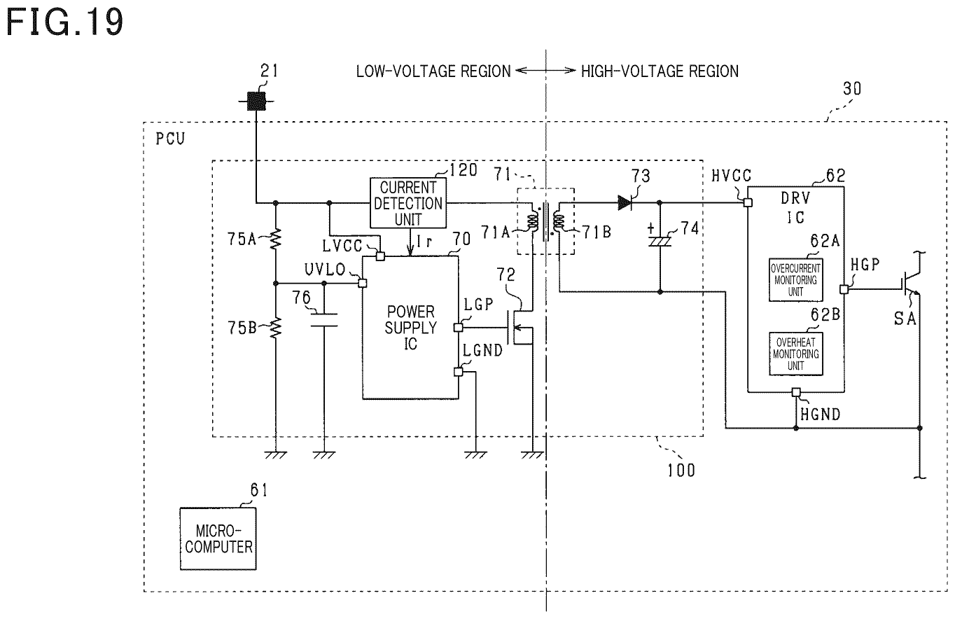

Hereinafter, a sixth embodiment will be described with reference to the drawings focusing on differences from the fourth embodiment. As illustrated in FIG. 19, the insulated power supply 100 of the present embodiment includes an input current detection unit 120 that detects a current flowing from the low-voltage storage battery 21 to the primary coil 71A. The input current detection unit 120 is, for example, a shunt resistor. The power supply IC 70 determines by itself the change of the switching frequency fsw based on a detection value of the input current detection unit 120.

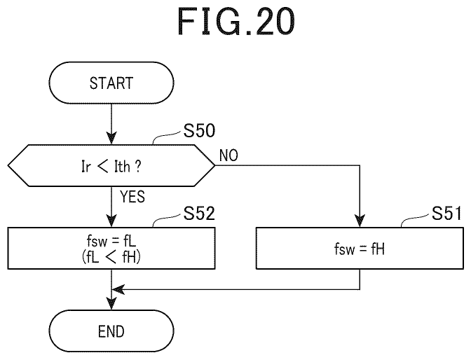

FIG. 20 is a flowchart of a process performed by the power supply IC 70.

In step S50, it is determined whether a detection current Ir of the input current detection unit 120 has been lower than a threshold value Ith for a determination time period. The determination time period is set to be longer than 1/fL. The threshold value Ith is set to, for example, a value close to 0. The processing of step S50 determines whether electric power is not fed from the low-voltage storage battery 21 to the primary coil 71A.

If a negative determination is made in step S50, the process proceeds to step S51, in which the switching frequency fsw of the control switch 72 is set to the first frequency fH. Then, the switching control of the control switch 72 is performed so that the switching frequency fsw of the control switch 72 becomes the first frequency fH.

In contrast, if an affirmative determination is made in step S50, the process proceeds to step S52, in which the switching frequency fsw of the control switch 72 is set to the second frequency fL. Then, the switching control of the control switch 72 is performed so that the switching frequency fsw of the control switch 72 becomes the second frequency fL.

According to the present embodiment described above, the power supply IC 70 can determine the change of the switching frequency fsw.

### Other Embodiments

The above embodiments may be modified as below.

In the fourth to sixth embodiments, instead of the switching frequency fsw, the output voltage may be changed as described in the second embodiment, or the switching speed may be changed as described in the third embodiment.

The insulated power supply, which is a switching power supply, is not limited to the flyback power supply, but may be a feedforward power supply or the like.

The switches included in the inverter are not limited to IGBTs but may be, for example, N-channel MOSFETS.

The inverter is not limited to a three-level inverter but may be a four or higher-level multilevel inverter or a two-level inverter. In addition, the inverter and the rotary electric machines are not limited to three-phase ones but may be two-phase ones or four or more-phase ones.

The rotary electric machine is not limited to a star-connected one but may be a Δ-connected one.

The electrical storage unit serving as a power supply of the inverter and subjected to external charging is not limited to a chargeable and dischargeable storage battery but may be a capacitor (e.g., electric double-layer capacitor) or both of the storage battery and the capacitor.

In addition, the electrical storage unit may be, for example, a fuel cell. In this case, for example, in a state in which the switching control of the inverter is stopped while the vehicle is stopped, when monitoring states of the switches of the inverter is required, the power supply device of the present disclosure is effective.

The movable body to which the power supply device is mounted is not limited to a vehicle but may be, for example, an aircraft or a boat. In addition, the power supply device may not be mounted to a movable body but may be a stationary device.

The control unit and the processing thereof described in the present disclosure may be implemented by a dedicated computer that is provided by configuring a processor and a memory that are programmed to execute one or more functions embodied by a computer program. Alternatively, the control unit and the processing thereof described in the present disclosure may be implemented by a dedicated computer that is provided by configuring a processor with one or more dedicated hardware logic circuits. Alternatively, the control unit and the processing thereof described in the present disclosure may be implemented by one or more dedicated computers that are configured by combining a processor and a memory that are programmed to execute one or more functions, with a processor that is configured by one or more hardware logic circuits. Furthermore, the computer program may be stored in a computer readable non-transitory tangible storage medium, as instructions to be executed by a computer.

The present disclosure has so far been described based on embodiments. However, the present disclosure should not be construed as being limited to these embodiments or the structures. The present disclosure should encompass various modifications, and modifications within the range of equivalence. In addition, various combinations and modes, as well as other combinations and modes, including those which include one or more additional elements, or those which include fewer elements should be construed as being within the scope and spirit of the present disclosure.

The present disclosure provides a power supply device applicable to a system, the system including an electrical storage unit (20), an inverter (50) connected to the electrical storage unit, a rotary electric machine (40) having armature windings (42U to 42W) connected to the inverter, and a drive circuit (62) driving a switch (Su1 to Sw4, SA) of the inverter,
the power supply device including a switching power supply (100) that has a power supply control unit (70) and supplies electric power to the drive circuit by switching control of the power supply control unit, wherein
the drive circuit is operated when the electric power is fed from the switching power supply and has a function of monitoring a state of the switch, and
the power supply control unit performs a change process that changes a switching manner of the switching power supply in a first state in which the electrical storage unit is charged from an external power supply (15) through the inverter or switching control of the switch is stopped, from a switching manner of the switching power supply in a second state in which the switching control of the switch for driving the rotary electric machine is performed.

According to the power supply device of the present disclosure, feeding electric power from a switching power supply to a drive circuit can be continued while suppressing influence of noise.

The power supply device of the present disclosure can be embodied, for example, as below.

The power supply control unit sets a switching frequency of the switching power supply in the second state to a frequency in a specific frequency range, and
the power supply control unit performs, as the change process, a process that shifts the switching frequency of the switching power supply in the first state to a frequency outside the specific frequency range.

The level of noise in the specific frequency range may be required to be a tolerance or lower in the first state. This requirement is, for example, a legislative requirement.

Hence, the power supply control unit performs, as the change process, a process that shifts the switching frequency of the switching power supply in the first state to a frequency outside the specific frequency range. Thus, while the level of noise is the tolerance or lower in the specific frequency range, feeding electric power from the switching power supply to the drive circuit can be continued.

What is claimed is:

1. A power supply device applicable to a system, the system including an electrical storage unit, an inverter connected to the electrical storage unit, a rotary electric machine having armature windings connected to the inverter, and a drive circuit driving a switch of the inverter, wherein
the system includes:
a loudspeaker; and
an AM receiver that detects and demodulates modulated waves that are obtained by modulating carrier waves using AM modulation, and outputs the demodulated waves to the loudspeaker as an audio signal,
the power supply device comprises a switching power supply that has a power supply control unit and supplies electric power to the drive circuit by switching control of the power supply control unit,
the drive circuit is operated when the electric power is fed from the switching power supply, and has a function of monitoring a state of the switch,
the power supply control unit performs a change process that changes a switching manner of the switching power supply in a first state in which the electrical storage unit is charged from an external power supply through the inverter or switching control of the switch is stopped, from a switching manner of the switching power supply in a second state in which the switching control of the switch for driving the rotary electric machine is performed,
the power supply control unit sets a switching frequency of the switching power supply in the second state to a frequency in a specific frequency range,
the power supply control unit performs, as the change process, a process that shifts the switching frequency of the switching power supply in the first state to a frequency lower than a lower limit of the specific frequency range, so that a level of noise produced due to switching control of the switching power supply becomes a tolerance or lower in the specific frequency range, and
a frequency range that the AM receiver is configured to receive is higher than the specific frequency range.

2. The power supply device according to claim 1, wherein
the power supply control unit determines whether a current state is the first state or the second state based on information transmitted from a control unit outside the power supply device, and
if determining that the current state is the first state, the power supply control unit performs the change process.

3. The power supply device according to claim 1, wherein
the power supply control unit determines whether a current state is the first state or the second state based on drive information of the drive circuit, and
if determining that the current state is the first state, the power supply control unit performs the change process.

4. The power supply device according to claim 1, wherein
the first state is a state in which the electrical storage unit is charged from the external power supply through the inverter,
the system includes a current sensor that detects a charging current flowing from the inverter to the electrical storage unit,
the power supply control unit determines whether a current state is the first state or the second state based on a detection value of the current sensor, and
if determining that the current state is the first state, the power supply control unit performs the change process.

5. The power supply device according to claim 1, further comprising an input current detection unit that detects an input current of the switching power supply and outputs the detected input current to the power supply control unit, wherein
the power supply control unit determines whether a current state is the first state or the second state based on a received detection value of the input current detection unit, and
if determining that the current state is the first state, the power supply control unit performs the change process.

6. A storage medium that stores a program applicable to a system, the system including an electrical storage unit, an inverter connected to the electrical storage unit, a rotary electric machine having armature windings connected to the inverter, a drive circuit driving a switch of the inverter, and a switching power supply that has a power supply control unit and supplies electric power to the drive circuit by switching control of the power supply control unit, wherein
the system includes:
a loudspeaker; and
an AM receiver that detects and demodulates modulated waves that are obtained by modulating carrier waves using AM modulation, and outputs the demodulated waves to the loudspeaker as an audio signal,
the drive circuit is operated when the electric power is fed from the switching power supply, and has a function of monitoring a state of the switch,
the program causes the power supply control unit to perform:
a process that determines whether a current state is a first state in which the electrical storage unit is charged from an external power supply through the inverter or switching control of the switch is stopped, or a second state in which the switching control of the switch for driving the rotary electric machine is performed; and
a change process that changes a switching manner of the switching power supply in a case in which it is determined that the current state is the first state, from a switching manner of the switching power supply in a case in which it is determined that the current state is the second state,
the switching manner of the switching power supply in the case in which it is determined that the current state is the second state sets a switching frequency of the switching power supply to a frequency in a specific frequency range,
the change process shifts the switching frequency of the switching power supply in the first state to a frequency lower than a lower limit of the specific frequency range, so that a level of noise produced due to switching control of the switching power supply becomes a tolerance or lower in the specific frequency range, and
a frequency range that the AM receiver is configured to receive is higher than the specific frequency range.

7. A control method applicable to a system, the system including an electrical storage unit, an inverter connected to the electrical storage unit, a rotary electric machine having armature windings connected to the inverter, a drive circuit driving a switch of the inverter, and a switching power supply that has a power supply control unit and supplies electric power to the drive circuit by switching control of the power supply control unit, wherein
the system includes:
a loudspeaker; and
an AM receiver that detects and demodulates modulated waves that are obtained by modulating carrier waves using AM modulation, and outputs the demodulated waves to the loudspeaker as an audio signal,
the drive circuit is operated when the electric power is fed from the switching power supply, and has a function of monitoring a state of the switch,
the method causes the power supply control unit to perform:
a process that determines whether a current state is a first state in which the electrical storage unit is charged from an external power supply through the inverter or switching control of the switch is stopped, or a second state in which the switching control of the switch for driving the rotary electric machine is performed; and
a change process that changes a switching manner of the switching power supply in a case in which it is determined that the current state is the first state, from a switching manner of the switching power supply in a case in which it is determined that the current state is the second state,
the switching manner of the switching power supply in the case in which it is determined that the current state is the second state sets a switching frequency of the switching power supply to a frequency in a specific frequency range,
the change process shifts the switching frequency of the switching power supply in the first state to a frequency lower than a lower limit (RL) of the specific frequency range, so that a level of noise produced due to switching control of the switching power supply becomes a tolerance or lower in the specific frequency range, and
a frequency range that the AM receiver is configured to receive is higher than the specific frequency range.
